(19) United States
(12) Patent Application Publication
(10) Pub. No.: US 2023/0289429 A1
(43) Pub. Date: Sep. 14, 2023

(54) AUTHENTICATION SYSTEM, CONTROL METHOD FOR AUTHENTICATION SYSTEM, AND STORAGE MEDIUM

(71) Applicant: CANON KABUSHIKI KAISHA, Tokyo (JP)

(72) Inventor: MASARU OKAZAKI, Tokyo (JP)

(21) Appl. No.: 18/178,335

(22) Filed: Mar. 3, 2023

(30) Foreign Application Priority Data
Mar. 11, 2022 (JP) 2022-038549

(51) Int. Cl. G06F 21/44

(52) U.S. Cl. CPC G06F 21/44

(57) ABSTRACT

An authentication system that performs authentication by limiting a use permission period of a function of a device and provides permission for use includes a determination unit configured to determine that the permission for use of the device has started, and a limitation unit configured to impose a limitation so that rewinding of the time does not exceed a predetermined range in response to a request for changing the time in a body of the device in a case where the determination unit determines that the permission for use has started.

### BACKGROUND

### Field of the Disclosure

The present disclosure relates to an authentication system, a control method for the authentication system, a storage medium, and the like.

### Description of the Related Art

In the related art, a system that performs authentication using a license file in order to permit use of application software has been operated. In addition, a system has been generally operated in which not a license file but a device connected to a network is connected to a server that performs license authentication, and an application requests authentication from a license authentication server at a convenient timing.

For example, there is a known technique for determining whether or not a device is permitted based on an identification number using a serial number unique to the equipment or a MAC address of a network-connected device as one piece of identification information. In addition, a mode for performing an operation of using a license form in which the date of start and the date of termination of use of a function are separated and periodically updating the expiration date of use of a license is also generally used.

Such a device is generally connected to a network, and a device that can synchronize according to time is often used. However, Japanese Patent Application Laid-Open No. 2017-208000 discloses a technique in which access tokens with expiration dates are issued and can be used offline.

Furthermore, many devices store time information so as to be able to obtain time information without being connected to a network and have a means for a user to change the time. Japanese Patent Application Laid-Open No. 2007-72533 discloses a technique for limiting a function that can be used when an operation of changing the date and time is performed by including a means to determine whether the date and time has been manipulated in order to prevent unauthorized use due to the change of the time.

However, when the time has been changed, the function is limited, and when the user attempts to use the corresponding function of application software later, the user may notice for the first time that the function cannot be used. In such a case, there is an issue that business or the like may be greatly obstructed.

### SUMMARY

Embodiments of the present disclosure provide an authentication system that performs authentication by limiting a use permission period of a function of a device and provides permission for use, the authentication system including one or more processors configured to function as a determination unit configured to determine that the permission for use of the device has started, and a limitation unit configured to impose a limitation so that rewinding of the time does not exceed a predetermined range in response to a request for changing the time in a body of the device in a case where the determination unit determines that the permission for use has started.

Further features of the present disclosure will become apparent from the following description of embodiments with reference to the attached drawings.

### BRIEF DESCRIPTION OF THE DRAWINGS

FIGS. 1A and 1B are diagrams illustrating an example of a system configuration according to a first embodiment of the present disclosure.

FIG. 2 is a hardware block diagram of a network camera according to the first embodiment.

FIG. 3 is a diagram illustrating an example of a software configuration of a network camera 101 according to the first embodiment.

FIG. 4 is a flowchart related to a control method for an authentication system according to the first embodiment.

FIG. 5 is a diagram illustrating an example of a time setting user interface according to the first embodiment.

FIG. 6 is a diagram illustrating an example of a user interface for giving a notification of time rewinding limitation according to the first embodiment.

FIG. 7 is a flowchart related to a control method for an authentication system according to a second embodiment.

FIG. 8 is a diagram illustrating an example of a user interface for registering a license file according to the second embodiment.

FIG. 9 is a diagram illustrating an example of a user interface for giving a notification of time rewinding limitation according to the second embodiment.

FIGS. 10A and 10B are diagrams illustrating an example of a time setting user interface according to the second embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

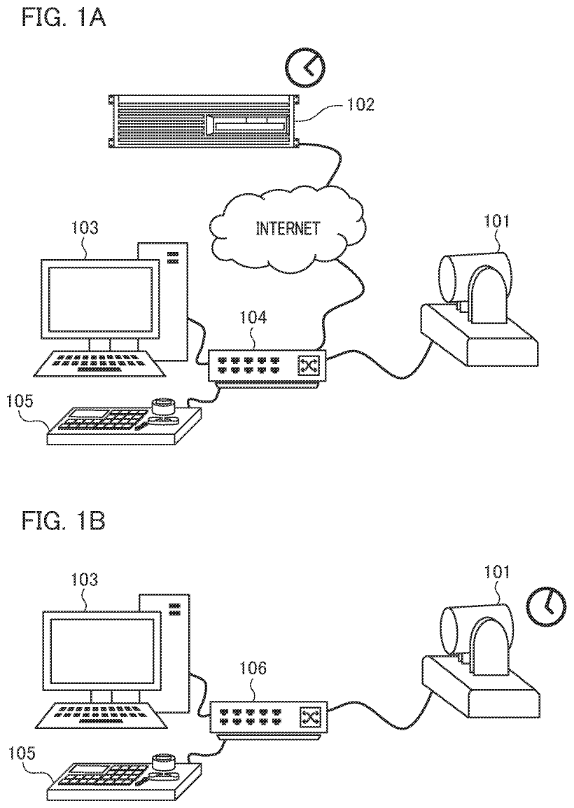

Hereinafter, a first embodiment will be described with reference to FIGS. 1 to 6. In the first embodiment, description will be given of an example in which an authentication system according to the first embodiment is incorporated in a network camera that can remotely control adjustment of an angle of view such as panning, tilting, and zooming, and imaging parameters such as exposure and a focal length.

Further, in the first embodiment, the authentication system incorporated in the network camera performs authentication by limiting a use permission period of the function of the network camera as a device, and provides permission for use. Further, the authentication system according to the first embodiment may be installed in electronic devices such as digital cameras, smartphones, personal computers, drones, and robots.

FIGS. 1A and 1B are diagrams illustrating an example of a system configuration according to the first embodiment of the present disclosure. FIG. 1A is a diagram illustrating an example of a system in which a network camera as an imaging device is connected to the Internet, and FIG. 1B is a diagram illustrating an example of a system in which the network camera is not connected to the Internet.

A network camera 101 in FIG. 1A operates as an NTP client synchronized in time with a network time protocol (NTP) server 102 installed on the Internet via a router 104.

In addition, the network camera 101 is controlled by transmitting and receiving commands via a network from a control PC 103 or a video controller 105 installed on the same network or a different network. A video acquired by the network camera 101 and compressed is transmitted to the control PC 103 or a recording apparatus, which is not illustrated in the drawing, via a network, and the video is stored in a storage held by the recording apparatus.

In such a system, when the network camera 101 is synchronized with the reliable NTP server 102, time information held by the network camera 101 can also be referred to as reliable time information.

However, the NTP server can also be established by an individual, and it cannot be said that a device synchronized with the NTP server established by the individual holds reliable time information.

In the related art, in a case where an authentication system that requires time information is established, it is an essential condition to operate the authentication system on a system synchronized with a reliable NTP server.

Next, in a case where a network camera system is established in a local network environment that is not connected to the Internet as illustrated in FIG. 1B, it is common to dispose and operate the control PC 103 on the same network as the network camera 101 via a hub 106.

In this case, the network camera 101 itself updates time information at all times based on its own clock information. In a case where the network camera 101 includes a means such as a user interface for changing time information, a user can freely set the time in the network camera 101.

Thus, even when an authentication system having the date and time of start and the date and time of termination is applied to the network camera 101 in such a system, unauthorized use can be easily made by changing the time information of the network camera 101.

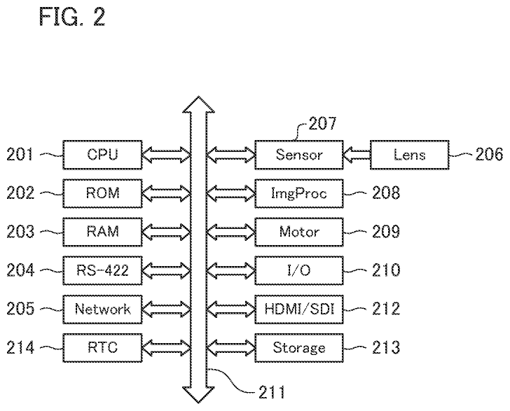

FIG. 2 is a hardware block diagram of a network camera according to the first embodiment, and the network camera 101 is equipped with an authentication system. In addition, the network camera 101 has a configuration similar to that of a general computer, in which a CPU 201 that controls the overall device and performs calculation, a ROM 202 that stores an OS, computer programs, and data, a RAM 203, and the like are connected to a bus 211. The ROM 202 is constituted by a flash memory, and some setting information can be written to the ROM 202.

Reference numeral 205 denotes a network controller which can control transmission and reception of commands to and from external devices and transmit and receive data such as videos, audio streams, and files. In addition, a photoelectric conversion sensor 207 that converts light having passed through a lens 206 into an electrical signal, an image processing apparatus 208 that performs development processing and image processing, and a motor 209 for controlling panning, tilting, zooming, a focal length, and an aperture are provided.

Further, a device I/O 210 such as a gyro for performing anti-vibration processing and an RS-422 interface 204 for receiving control information from the video controller 105 are also connected to the bus 211.

In addition, the network camera 110 transmits an uncompressed video to a recording apparatus and a switcher (both are not illustrated in the drawing) through a serial digital interface (SDI) 212. In addition, the image processing apparatus 208 can generate compressed videos such as those of JPEG, H.264, HEVC, and VVC, and can transmit a video to a network via a UTP cable or the like through the network controller 205.

In addition, setting value information and license authentication information targeted in the first embodiment are stored in a storage 213. The storage 213 may be substituted by allocating a portion of the flash memory in the ROM 202 to a readable/writable storage (file system). Reference numeral 214 denotes a real-time clock that updates the time at all times even when a main power supply is turned off. In addition, authentication information (license file) is stored in the ROM 202.

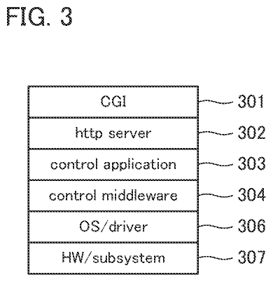

FIG. 3 is a diagram illustrating a software configuration example of the network camera 101 according to the first embodiment. The network camera 101 is equipped with an http server 302 that transfers HTML and Java (registered trademark) script to a web browser of the PC 103 and displays an operation screen of the network camera on the web browser of the PC 103. The HTML and Java script described above are implemented to operate a common gateway interface (CGI) 301 built in the network camera by user's operation.

Depending on the content of the CGI 301, a control application 303 for calling the functions of the camera is called. The control application is a software layer for satisfying main functions of the network camera, such as application software that operates focusing and zooming of the camera, panning, and tilting.

In addition, the control application 303 includes application software for performing video distribution using a real-time transport protocol (RTP) or http, an application for performing video recognition, and the like.

In addition, since software of the network camera is large in scale, the software includes layers of an OS and a device driver 306 and includes middleware 304 which is an abstracted layer. In addition, the device driver 306 controls communication with hardware and subsystems that perform communication and video/audio encoding. Reference numeral 307 denotes a hardware subsystem.

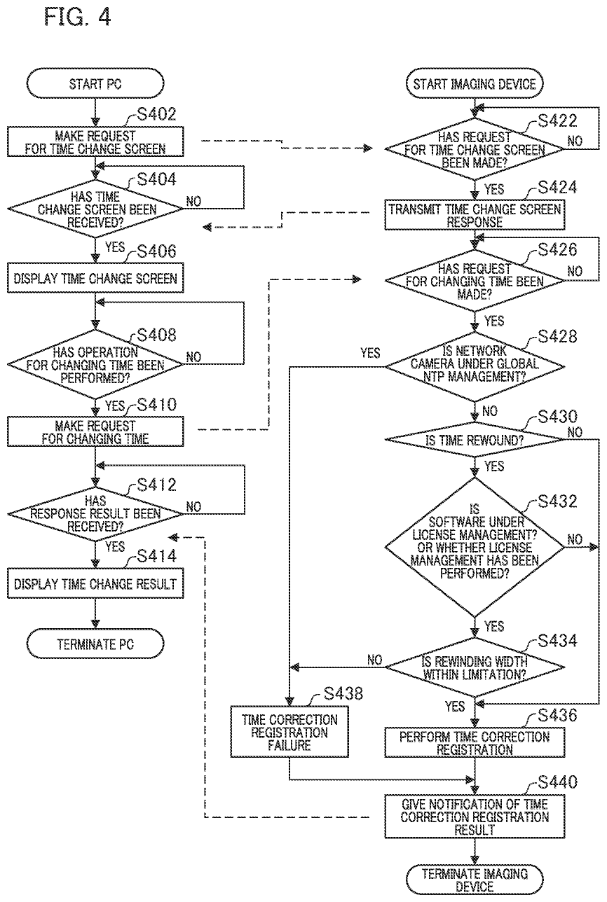

Next, an operation related to rewinding of the time in the first embodiment will be described with reference to FIGS. 4 to 6. FIG. 4 is a flowchart related to a control method for the authentication system according to the first embodiment.

A flowchart of the control PC 103 is illustrated on the left side of FIG. 4, and a flowchart of the network camera 101 is illustrated on the right side. In addition, a computer in the control PC 103 and the CPU 201 of the network camera 101 execute computer programs stored in the memory, so that operations of respective steps in the flowcharts of FIG. 4 are performed.

First, in step S402, the PC 103 requests a screen for changing the time from the web browser. The network camera 101 receives the request for the time change screen in step S422, and transmits HTML or Java script corresponding to the time change screen to the PC 103 in step S424.

In step S404, the PC 103 waits until the time change screen is received, and when the PC 103 receives the content of the time change screen, the time change screen is displayed on the web browser in step S406.

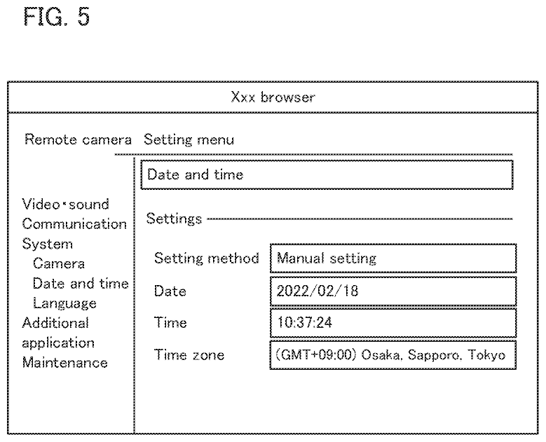

FIG. 5 is a diagram illustrating an example of a time setting user interface according to the first embodiment, and the time change screen as illustrated in FIG. 5 is displayed on the web browser.

When the user performs a time change operation in step S408, a corresponding time change request is made to the network camera 101 in step S410. In step S426, the network camera 101 determines whether or not a time change request has been made, and waits until the time change request is made. Then, when the time change request is made in step S410, the CGI 301 of the network camera 101 is started in step S428.

In step S428, the CGI 301 of the network camera determines whether or not the network camera is under the control of a global and reliable NTP (network time protocol) server which is set in advance.

In a case where the network camera is under the control of the NTP server, it is not necessary to change the time, and thus a “time correction registration failure” is set in step S438. That is, in a case where time synchronization is performed using a time synchronization system such as an NTP server designated by the authentication system, the time is not changed even when a time change request is made.

On the other hand, in a case where it is determined in step S428 that the network camera is under the control of the global NTP server, it is determined in step S430 whether or not the content of the time change indicates a change for rewinding the time. In the case of No (in a case where it is determined that the content of the time change indicates a change for advancing the time), the flow proceeds to step S436 to correct the time. In the case of Yes in step S430 (in a case where it is determined that the content of the time change indicates a change for rewinding the time), the flow proceeds to step S432.

Then, in step S432, it is determined whether predetermined software is currently in a license authentication period (under license management) or whether there is a history of license authentication in the past for the software (whether license management has been performed).

Here, step S432 functions as a determination step (determination unit) of determining whether permission for use (license management) of the device has been started (whether permission for use is started at present or was started in the past).

When it is not a license authentication period at present and license authentication was not performed in the past, time correction registration is permitted in step S436 to change the time of the real-time clock 214 in the body of the network camera 101 as a device.

On the other hand, in a case where it is a license authentication period at present and license management was performed (license authentication was performed) in the past, it is determined in step S434 whether a rewinding time width is within a preset limit width (predetermined range).

When the rewinding time width is within the limit width, time correction registration is performed in step S436. That is, when the rewinding time width is within the predetermined range, the change of the time in the body of the device (network camera 101) is permitted. On the other hand, in a case where the rewinding time width is out of the limit width (predetermined range), a “time correction registration failure” is set in step S438, a limitation for prohibiting the change of the time is imposed.

That is, in a case where the device (network camera 101) performs time synchronization using a time synchronization system that is not designated by the authentication system, a limitation is imposed such that the rewinding time width is set to be a preset limit width (predetermined range).

Here, steps S434 and S438 function as a limitation step (limitation unit) for making a limitation such that the rewinding of the time does not exceed a predetermined range in response to a request for changing the time in the body of the device.

In addition, the preset rewinding limitation width (predetermined range) is, for example, the range of rewinding time within a unit time, and is set to, for example, 6 hours per day, or the like. The rewinding limitation width is determined according to the usage and policy of an object (software) to be subjected to license management, and may be set automatically when the object (software) to be subjected to license management is installed.

In step S440, the network camera 101 generates HTML representing a determination result (time correction registration result) indicating whether time correction has been successful in step S436 or a “time correction registration failure” has been set in step S438, and notifies the PC 103 of the HTML. Thereafter, the flow on the network camera 101 side in FIG. 4 is terminated.

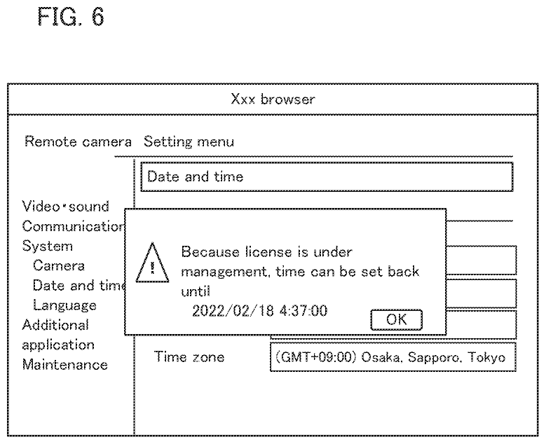

The PC 101 waits to receive a response result to the time change request in step S412, and proceeds to step S414 when receiving the time correction registration result to display the time change result on the web browser. That is, in a case where time correction has been registered in step S434, the registration is displayed, and in a case where the “time correction registration failed” has been set in step S438, a display as in FIG. 6 is performed. Thereafter, the flow on the PC 103 side in FIG. 4 is terminated.

FIG. 6 is a diagram illustrating an example of a user interface for giving a notification of time rewinding limitation according to the first embodiment. FIG. 6 illustrates an example of display of a determination result, for example, in a case where it is determined in step S434 that license management is being performed or license management was performed in the past, and the rewinding limitation width is exceeded.

As illustrated in FIG. 6, in the first embodiment, when a result indicating a “time correction registration failure” is displayed in step S438, the reason for the failure and a rewindable range are displayed. In addition, when rewinding is performed on the display screen, the time is changed so as not to exceed a predetermined range.

In the first embodiment, a time change request is received even under NTP management in the flowchart of FIG. 4, but a “time correction registration failure” is set. To avoid this, in a case where time settings can be changed by the user interface, a time setting change menu may not be output to the user interface during NTP management.

Further, in the first embodiment, an example in which a limit width (predetermined range) of time rewinding is set to 6 hours has been described, but the limit width may be set to 0 seconds to less than 24 hours per day.

Alternatively, rewinding of the time may be permitted to the extent that it does not return to an expired authentication period of a license file set in the past. That is, in a case where a use permission period has expired, a limit width (predetermined range) of time rewinding may be set not to fall within the use permission period that has expired.

Further, although an example in which the authentication system is applied to a network camera has been described in the first embodiment, a devices to which the authentication system is applied is not limited to the network camera, and the first embodiment can be applied to any electronic device.

As described above, in the first embodiment, in a case where unique time information is stored in a device that requires license management, a limitation is imposed on a rewinding range of time information when license management is started. Thus, it is possible to prevent unauthorized use of license authentication using the time information.

### Second Embodiment

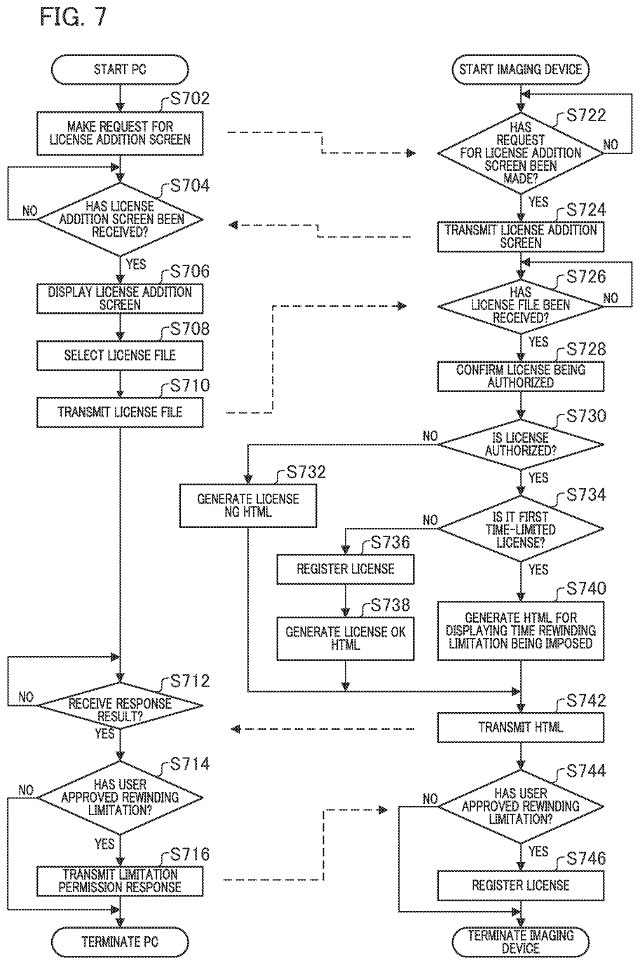

Hereinafter, a second embodiment of the present disclosure will be described with reference to FIGS. 7 to 10. In the second embodiment, when a license is added for the first time or when time setting are changed, a user is notified that a limitation is imposed to rewinding of the time.

FIG. 7 is a flowchart related to a control method for an authentication system according to the second embodiment, and operations of a control PC 103 and a network camera 101 when adding an authentication license, and the like will be described with reference to FIG. 7.

In addition, a computer in the control PC 103 and a CPU 201 of the network camera 101 execute computer programs stored in their memories, so that operations of steps in the flowchart of FIG. 7 are performed.

In FIG. 7, it is assumed that the PC 103 displays a setting change screen on a web browser in order to change the settings of the network camera 101 via the web browser.

In this state, in step S702, the PC 103 requests a license addition screen from the network camera. The network camera 101 waits for the license addition screen request in step S722, and when the network camera 101 receives the license addition screen request, the network camera 101 generates HTML corresponding to a license addition screen and transmits the generated HTML, to the PC 103 in step S724.

The PC 103 waits to receive the license addition screen in step S704, and when the PC 103 receives the license addition screen, the PC 103 displays the license addition screen on a browser of the PC in step S706.

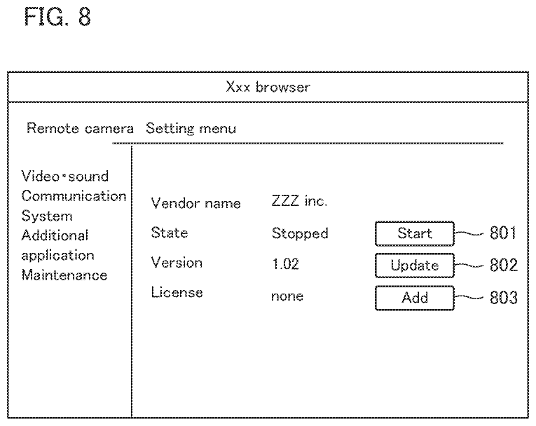

FIG. 8 is a diagram illustrating an example of a user interface for registering a license file according to the second embodiment. In this example, a start button 801 for starting an application, an update button 802 for searching for and installing an application of a new version, and an add button 803 for adding a license are disposed for a specific application.

When the user presses the button 803 for adding a license, a dialog for selecting a file on a file system or a network accessible from the PC is displayed in step S708. When the user selects a license file in step S710, the PC 103 transmits the selected license file to the network camera 101.

The network camera 101 waits to receive the license file in step S726, and when the network camera 101 receives the license file, the network camera 101 confirms the content of the license file in step S728 and determines whether or not the license file is authorized. For example, it is determined that the license file is authorized, for example, in a case where both (1) a condition that necessary items are included and (2) a condition that a digitally sign is correctly written are satisfied.

In a case where it is determined in step S730 that the license is not authorized, HTML for giving a notification that the license is unauthorized (NG) is generated in step S732, and the generated HTML is transmitted to the PC 103 in step S742.

On the other hand, in a case where it is determined in step S730 that the license is authorized, it is determined in step S734 whether or not the license is a time-limited license (a license with an expiration date) and whether or not the license is to be registered for the first time.

In the case of No, the license file is registered in the network camera 101 in step S736, HTML indicating that the license is authorized and has been registered is generated in step S738, and the HTML is transmitted to the PC 103 in step S742.

In the case of Yes in step S734, HTML indicating that a time rewinding limitation is imposed is generated in step S740, and the HTML is transmitted to the PC 103 in step S742.

The PC 103 waits to receive a response result (HTML) from the network camera 101 in step S712, and displays the HTML on the display screen of the PC when the HTML is received. In step S712, when the HTML generated in step S732 is received, “License NG” is displayed. In addition, when the HTML generated in step S738 is received, “License OK” is displayed.

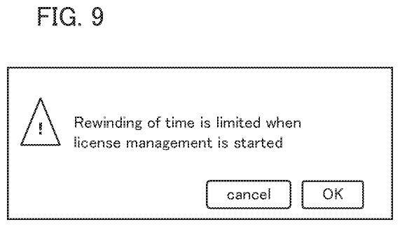

In addition, when the HTML generated in step S740 and indicating that a time rewinding limitation is imposed has been received, for example, a display as illustrated in FIG. 9 is performed. Here, step S712 functions as a notification step (notification unit) for notifying the user of the time rewinding limitation when it is determined that permission for use has been started.

FIG. 9 is a diagram illustrating an example of a user interface for notifying a time rewinding limitation according to the second embodiment. FIG. 9 illustrates an example of display in a case where HTML generated in step S740 and indicating that the time rewinding limitation is imposed is displayed.

Further, in the second embodiment, in a case where a license is a time-limited license (a license with an expiration date) and the license is registered for the first time, the imposition of a rewinding limitation is displayed. However, the imposition of a rewinding limitation may also be displayed when the license is registered for the second and subsequent times.

In step S714, the PC 103 waits whether or not the user approves a rewinding limitation, and when the user selects OK in the display of FIG. 9, the PC 103 transmits a response indicating that a restriction on a rewinding limitation has been approved to the network camera 101 in step S716. Thereafter, the flow on the PC 103 side in FIG. 7 is terminated.

In a case where the network camera 101 determines that the message has been received, the flow proceeds to step S746, and the license received in step S726 is registered to terminate the flow on the network camera side in FIG. 7.

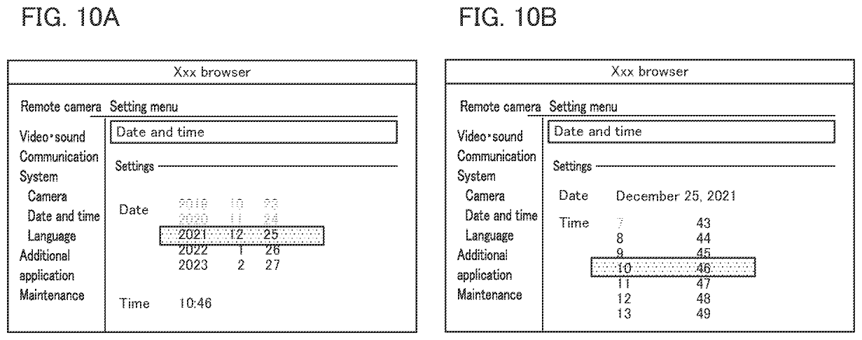

Thereafter, a restriction will be imposed on the change of the time as described in the first embodiment, but in the second embodiment, as illustrated in FIG. 10, the time can be set within a range permitted to change the time in the user interface.

FIGS. 10A and 10B are diagrams illustrating an example of a user interface for setting the time according to the second embodiment. FIG. 10A is a diagram illustrating an example of a user interface for setting the date. The example of the user interface shows an example in which the setting is changed to Dec. 25, 2021, and the dates before Dec. 25, 2021 are grayed out so as not to be selected.

Similarly, FIG. 10B is a diagram illustrating an example of a user interface for setting the time. This example shows a case where the current time of the network camera is 10:46, which indicates a situation where the time more than 3 hours before the current time cannot be set and the time in the range of 7:00 cannot be set.

In this manner, in the second embodiment, the user is notified that a limitation is imposed on the rewinding of a license at the time of starting license management of the network camera 101 for the first time. Further, a rewinding limitation of the data and time is imposed in the user interface for changing the setting of the time.

Further, once all the license files can be deleted and the time can be rewound, unauthorized use can be performed, and thus once the license management is started, it is desirable to continue a time rewinding limitation even when all of the license files are deleted.

Further, in the second embodiment, an example in which the user is notified that a limitation is imposed on time rewinding through the user interface at the time of starting license management has been described. However, when the time is changed in the body of the device, the user may be notified that a limitation is imposed on the rewinding of the time.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the authentication system through a network or various storage media. Then, a computer (or a CPU, an MPU, or the like) of the authentication system may be configured to read and execute the program. In such a case, the program and the storage medium storing the program configure the present disclosure.

This application claims the benefit of Japanese Patent Application No. 2022-038549 filed on Mar. 11, 2022, which is hereby incorporated by reference herein in its entirety.

What is claimed is:

1. An authentication system that performs authentication by limiting a use permission period of a function of a device and provides permission for use, the authentication system comprising:
one or more processors configured to function as:
a determination unit configured to determine that the permission for use of the device has started; and
a limitation unit configured to impose a limitation so that rewinding of the time does not exceed a predetermined range in response to a request for changing the time in a body of the device in a case where the determination unit determines that the permission for use has started.

2. The authentication system according to claim 1, wherein the limitation unit permits the change of the time in the body of the device when the rewinding of the time is within the predetermined range.

3. The authentication system according to claim 1, wherein the predetermined range is a range of rewinding time within a unit time.

4. The authentication system according to claim 1, wherein the predetermined range includes 0 seconds.

5. The authentication system according to claim 1, wherein the predetermined range is a range of less than 24 hours per day.

6. The authentication system according to claim 1, wherein, in a case where the device is performing time synchronization using a time synchronization system designated by the authentication system, the time is not changed even when a request for changing the time is made.

7. The authentication system according to claim 1, wherein, in a case where the device is performing time synchronization using a time synchronization system which is not designated by the authentication system, the limitation unit performs the limitation.

8. The authentication system according to claim 1, the one or more processors further configured to function as:
a notification unit configured to notify a user of a limitation on rewinding of the time in a case where the determination unit has determined that the permission for use has started.

9. The authentication system according to claim 1, wherein, in a case where a request for changing the time in the body of the device has been made, the notification unit notifies the user of a limitation on rewinding of the time.

10. The authentication system according to claim 1, wherein, in a case where the use permission period has expired, the predetermined range is set not to fall within the use permission period that has expired.

11. A control method for an authentication system that performs authentication by limiting a use permission period of a function of a device and provides permission for use, the control method comprising:
determining that the permission for use of the device has started; and
imposing a limitation so that rewinding of the time does not exceed a predetermined range in response to a request for changing the time in a body of the device in a case where it is determined that the permission for use has started.

12. A non-transitory computer-readable storage medium storing a computer program including instructions, which when executed by one or more processors of an authentication system that performs authentication by limiting a use permission period of a function of a device and provides permission for use, cause the authentication system to perform operations comprising:
determining that the permission for use of the device has started; and
imposing a limitation so that rewinding of the time does not exceed a predetermined range in response to a request for changing the time in a body of the device in a case where it is determined that the permission for use has started.
